(19) United States
(12) Patent Application Publication
(10) Pub. No.: US 2026/0116449 A1
(43) Pub. Date: Apr. 30, 2026

(54) Roller Wagon Device

(71) Applicants: Benjamin Hinojosa, McAllen, TX (US); Romeo Garza, McAllen, TX (US)

(72) Inventors: Benjamin Hinojosa, McAllen, TX (US); Romeo Garza, McAllen, TX (US)

(21) Appl. No.: 19/218,803

(22) Filed: May 27, 2025

Related U.S. Application Data
(60) Provisional application No. 63/713,104, filed on Oct. 29, 2024.

(51) Int. Cl. B62B 3/02; B62B 5/00; B62B 5/06

(52) U.S. Cl. CPC B62B 3/022; B62B 5/0053; B62B 5/0076; B62B 5/067; B62B 2301/254; B62B 2301/33; B62B 2301/34

(57) ABSTRACT

A roller wagon device is provided comprised of a wagon designed for efficient movement of items over challenging terrains, particularly for outdoor activities like camping and beach outings. The device comprises a high-capacity, stable wagon body supported by a foldable frame made of lightweight materials, allowing easy storage and transport. The body includes multiple fasteners for securing additional items, pockets for organizing smaller items, and optional dividers for customizing the interior space. For maneuverability, the wagon features a handle with a non-slip grip. Equipped with specialized roller assemblies, including self-cleaning brushes, the device maintains smooth movement across sand and other uneven surfaces. An optional motorized version includes an electric motor powered by a rechargeable battery, which can be solar charged, allowing minimal physical effort during transport. Additionally, a wireless remote provides control over speed and direction, enhancing ease of use, particularly when managing heavy loads across extended distances.

### CROSS-REFERENCE TO RELATED APPLICATION

The present application claims priority to, and the benefit of, U.S. Provisional Application No. 63/713,104, which was filed on Oct. 29, 2024, and is incorporated herein by reference in its entirety.

### FIELD OF THE INVENTION

The present invention relates generally to the field of wagons. More specifically, the present invention relates to a wagon optimized for moving items over rough terrains, featuring a high-capacity body with adjustable fasteners, pockets, and dividers, along with ergonomic handles and self-cleaning rollers for smooth maneuverability. A motorized version powered by a rechargeable solar battery and controllable via wireless remote enables effortless transport of heavy loads over long distances. Accordingly, the present disclosure makes specific reference thereto. Nonetheless, it is to be appreciated that aspects of the present invention are also equally applicable to other like applications, devices, and methods of manufacture.

### BACKGROUND

Transporting necessary items across outdoor environments, such as campsites, beach areas, and tailgate events, presents significant challenges when using traditional carts and wagons. These common transport tools typically have small, narrow, or rigid wheels that do not handle soft or uneven terrain well. As a result, moving these carts over sand, gravel, or dirt paths often requires considerable effort, especially when they are loaded with heavy gear. Many users experience frustration as the wheels become bogged down or catch on rough surfaces, which can drastically slow down their movement and require extra physical strain. For individuals who regularly bring equipment, food, chairs, and other supplies to remote or outdoor locations, this difficulty adds a significant inconvenience, often making the task feel impractical or unfeasible. Furthermore, as the wheels roll over sand and loose debris, they tend to accumulate materials that clog the movement mechanism, requiring users to frequently clean the wheels to restore functionality. This maintenance adds time to the process and detracts from the overall experience of transporting items efficiently. Thus, many outdoor enthusiasts and eventgoers face a persistent problem in efficiently transporting their essentials across challenging terrains.

Therefore, there exists a long-felt need in the art for a roller wagon device that can move smoothly over rough and uneven terrain without excessive effort. There also exists a long-felt need in the art for a roller wagon device that allows users to carry heavy loads without compromising maneuverability. Moreover, there exists a long-felt need in the art for a roller wagon device that minimizes the buildup of dirt and debris on its movement mechanism, ensuring consistent performance.

The subject matter disclosed and claimed herein, in one embodiment thereof, comprises a roller wagon device. The device is comprised of a wagon designed for efficient movement of items over challenging terrains, particularly for outdoor activities like camping and beach outings. The device comprises a high-capacity, stable wagon body supported by a foldable frame made of lightweight materials, allowing easy storage and transport. The body includes multiple fasteners for securing additional items, pockets for organizing smaller items, and optional dividers for customizing the interior space. For maneuverability, the wagon features an ergonomic, extendable handle with a non-slip grip. Equipped with specialized roller assemblies, including self-cleaning brushes, the device maintains smooth movement across sand and other uneven surfaces. An optional motorized version includes an electric motor powered by a rechargeable battery, which can be solar charged, allowing minimal physical effort during transport. Additionally, a wireless remote provides control over speed and direction, enhancing case of use, particularly when managing heavy loads across extended distances.

In this manner, the roller wagon device of the present invention accomplishes all the forgoing objectives and provides specialized rollers designed to traverse rough surfaces like sand, dirt, and gravel. These rollers reduce the friction and resistance typically encountered with standard wheels, enabling smoother movement even with added weight. Integrated brushes work automatically to clear sand and debris from the rollers as the wagon moves, enhancing performance and reducing maintenance. Additionally, the roller wagon device provides side straps for securely carrying accessories, while its large open interior accommodates a variety of items. An optional motorized version offers further convenience, supporting case of transport across challenging terrain and meeting the varied needs of outdoor enthusiasts.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a roller wagon device. The device is a wagon designed for efficient transportation of items across challenging terrains, such as sand, dirt, and gravel, making it suitable for outdoor activities like camping and beach outings. It comprises a wagon body optimized for load capacity and stability, constructed from durable materials like rigid plastics, metals, or reinforced fabrics. The body is supported by a lightweight, robust frame, made of materials such as aluminum or steel. The frame may be foldable, incorporating at least one hinge to allow the device to collapse for easy storage and transport while maintaining structural integrity.

The body includes multiple fasteners, such as straps, clips, or hook-and-loop fasteners, enabling secure attachment of additional items for transport over rough terrain. A large internal volume allows for a range of items to be carried, with optional interior or exterior pockets for organizing smaller items. Adjustable or removable dividers can be used to customize the internal space, providing further organization flexibility.

For maneuverability, the device features at least one handle, available in ergonomic styles like telescopic or loop handles. The telescopic handle can extend or retract and lock in place using a fastener. A non-slip grip area, made from rubber or silicone and featuring textured surfaces, ensures a secure and comfortable hold in various conditions.

The device includes at least one roller assembly with rollers that rotate around an axle, allowing smooth movement across soft or uneven surfaces. Each roller may have a tread pattern to improve traction, and a self-cleaning brush positioned above the roller clears sand and debris, reducing the need for manual cleaning and maintaining smooth movement over extended distances.

A powered version of the device includes at least one electric motor integrated with the roller assemblies, enabling users to transport heavy loads with minimal effort. The motor is powered by a rechargeable battery, continuously charged by a solar panel mounted on the body. The solar panel is designed with high-efficiency photovoltaic cells for optimal energy capture, converting sunlight into electrical energy for storage in the battery.

The battery, a high-capacity lithium-ion or lithium-polymer type, is selected for outdoor durability and energy density, powering the motor to facilitate movement across difficult terrain. A remote control allows wireless control of the device's speed and direction, featuring at least one button for communication with the motor via Bluetooth or RF, making the device easy to operate even over long distances or with heavy loads.

Accordingly, the roller wagon device of the present invention is particularly advantageous as it provides specialized rollers designed to traverse rough surfaces like sand, dirt, and gravel. These rollers reduce the friction and resistance typically encountered with standard wheels, enabling smoother movement even with added weight. Integrated brushes work automatically to clear sand and debris from the rollers as the wagon moves, enhancing performance and reducing maintenance. Additionally, the roller wagon device provides side straps for securely carrying accessories, while its large open interior accommodates a variety of items. An optional motorized version offers further convenience, supporting case of transport across challenging terrain and meeting the varied needs of outdoor enthusiasts. In this manner, the roller wagon device overcomes the limitations of existing wagons known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a roller wagon device of the present invention in accordance with the disclosed architecture;

FIG. 2 illustrates an enhanced perspective view of a roller assembly of one potential embodiment of a roller wagon device of the present invention in accordance with the disclosed architecture; and

FIG. 3 illustrates an enhanced perspective view of a fastener of one potential embodiment of a roller wagon device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a roller wagon device that can move smoothly over rough and uneven terrain without excessive effort. There also exists a long-felt need in the art for a roller wagon device that allows users to carry heavy loads without compromising maneuverability. Moreover, there exists a long-felt need in the art for a roller wagon device that minimizes the buildup of dirt and debris on its movement mechanism, ensuring consistent performance.

The present invention, in one exemplary embodiment, is comprised of a roller wagon device. The device is a wagon intended for efficient transport of items over challenging terrains, such as sand, dirt, and gravel, making it ideal for outdoor activities like camping and beach outings. The wagon comprises a body optimized for load capacity and stability, constructed from durable materials like rigid plastics, metals, or reinforced fabrics. This body is supported by a lightweight yet sturdy frame made of materials such as aluminum or steel. The frame may be foldable, with at least one hinge enabling the device to collapse for convenient storage and transport while preserving structural integrity.

The body includes various fasteners, such as straps, clips, or hook-and-loop closures, allowing secure attachment of additional items for transport over rough terrain. Its large internal volume accommodates a range of items, with optional interior or exterior pockets for organizing smaller items. Adjustable or removable dividers allow for flexible internal organization.

For enhanced maneuverability, the device features at least one handle, available in ergonomic designs like telescopic or loop styles. The telescopic handle can extend or retract and is lockable via a fastener. A non-slip grip area, made from rubber or silicone and textured for additional traction, ensures secure and comfortable handling in diverse conditions.

The device includes at least one roller assembly with rollers rotating around an axle, allowing smooth movement across soft or uneven surfaces. Each roller may have a tread pattern to improve traction, while a self-cleaning brush positioned above the roller removes sand and debris, reducing the need for manual cleaning and maintaining smooth movement over extended distances.

A powered version of the device includes at least one electric motor integrated with the roller assemblies, allowing users to transport heavy loads with minimal effort. The motor is powered by a rechargeable battery, which is continuously charged by a solar panel mounted on the body. The solar panel, comprising high-efficiency photovoltaic cells, optimizes energy capture by converting sunlight into electrical energy for storage in the battery.

The battery, a high-capacity lithium-ion or lithium-polymer type, is chosen for outdoor durability and energy density, supplying power to the motor to facilitate movement over difficult terrain. A remote control allows wireless adjustment of the device's speed and direction, featuring at least one button for motor communication via Bluetooth or RF, making the device easy to operate over long distances or with heavy loads.

The roller wagon device provides unique advantages, with specialized rollers for navigating rough surfaces like sand, dirt, and gravel, minimizing friction and resistance compared to standard wheels. Integrated brushes clear debris from the rollers as the wagon moves, enhancing performance and reducing maintenance. Additionally, side straps secure accessories, and a large open interior accommodates various items. An optional motorized version offers added convenience, casing transport across challenging terrain and addressing the diverse needs of outdoor users, thus overcoming limitations of existing wagon designs.

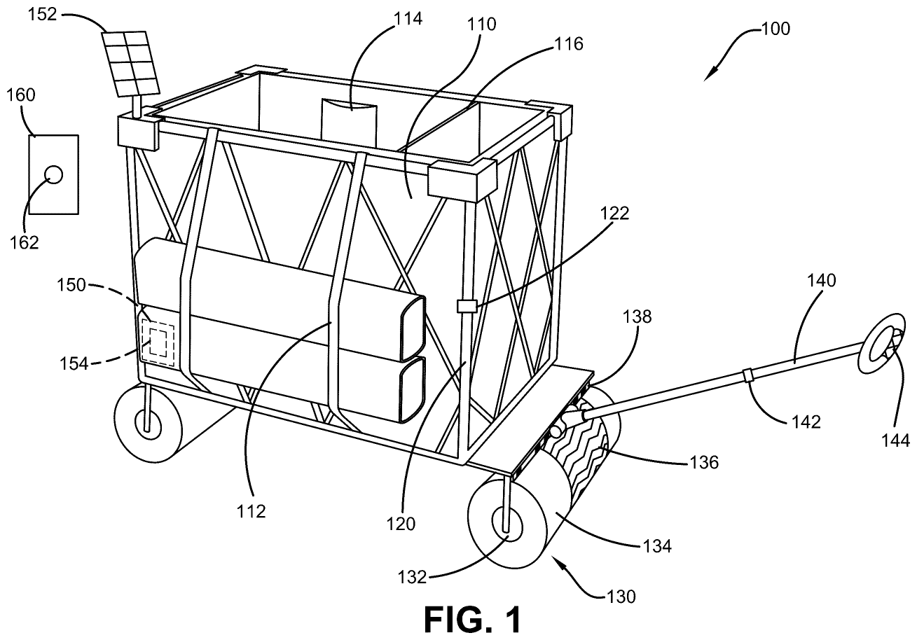

Referring initially to the drawings, FIG. 1 illustrates a perspective view of one potential embodiment of a roller wagon device 100 of the present invention in accordance with the disclosed architecture. The device 100 is comprised of a wagon intended for efficient transport of items across challenging terrains such as sand, dirt, and gravel, making it especially suitable for outdoor activities like camping, beach outings, and tailgating. More specifically, the device 100 is comprised of a wagon body 110, which may take any shape optimized to maximize load capacity and ensure stability. The body 110 may be constructed from materials such as rigid plastics, metals, or reinforced fabrics. The body 110 is supported by a frame 120, preferably made from robust but lightweight materials like aluminum, steel, or polymer, which provides structural strength without adding unnecessary weight. In one embodiment, the frame 120 is foldable, featuring at least one hinge 122 that allows the entire device 100 to collapse for convenient storage and transport. The hinge 122, which may be a pivot hinge, a locking hinge, etc., ensures the frame 120 maintains its integrity during both use and storage.

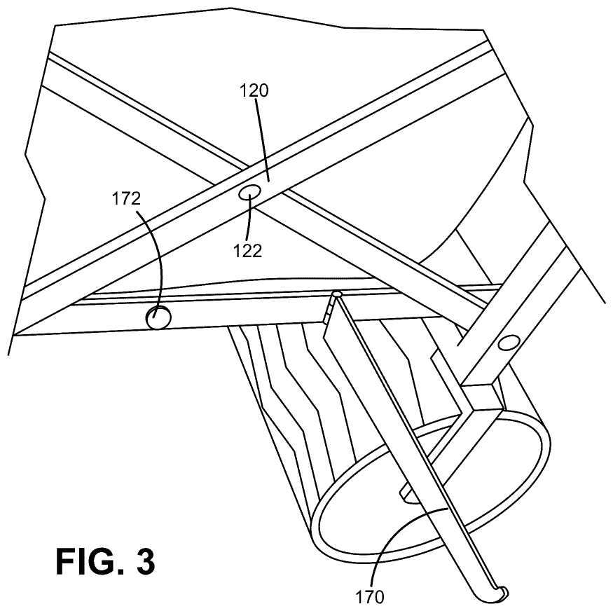

The body 110 may be comprised of multiple exterior and/or interior fasteners 112, such as adjustable straps with buckles, hook-and-loop fasteners, or clips, which are distributed along the sides of the body 110. These fasteners 112 provide secure attachment points for additional items, such as beach chairs, tents, and other outdoor gear, allowing users to transport bulky items without them shifting or detaching, even on rough terrain. The body 110 also features a large internal volume, allowing users to carry a wide range of items required for activities like beach trips, camping, or tailgating. In one embodiment, the body 110 is comprised of at least one fastener 170 that is preferably a hinged support bracket, as seen in FIG. 3. The fastener 170 can be folded outwards from the body 110 to support the weight of items secured by the fastener 112. When not in use, the fastener 170 can be folded flush with the body 110 via at least one secondary fastener 172, such as but not limited to a magnet.

Additionally, at least one exterior or interior pocket 114 may be incorporated for organizing smaller items, preventing them from mixing with larger cargo and keeping them easily accessible. To further aid organization, the body 110 may be equipped with at least one adjustable or removable divider 116, enabling users to customize the internal space and separate items as needed.

To facilitate maneuverability, the device 100 includes at least one handle 140, which may be designed in various ergonomic styles, such as a telescopic handle, loop handle, or bar grip. In one embodiment, the handle 140 is telescopic, allowing the handle 140 to extend or retract as desired and can be securely locked in place using a fastener 142, such as a push-button lock or clasp. For improved handling, the handle 140 includes a grip area 144, made from non-slip materials like rubber or silicone, to ensure a secure hold even in wet or sandy conditions. Additionally, the grip area 144 may feature raised or recessed textures, such as ridges or grooves, which provide added traction and comfort for the user.

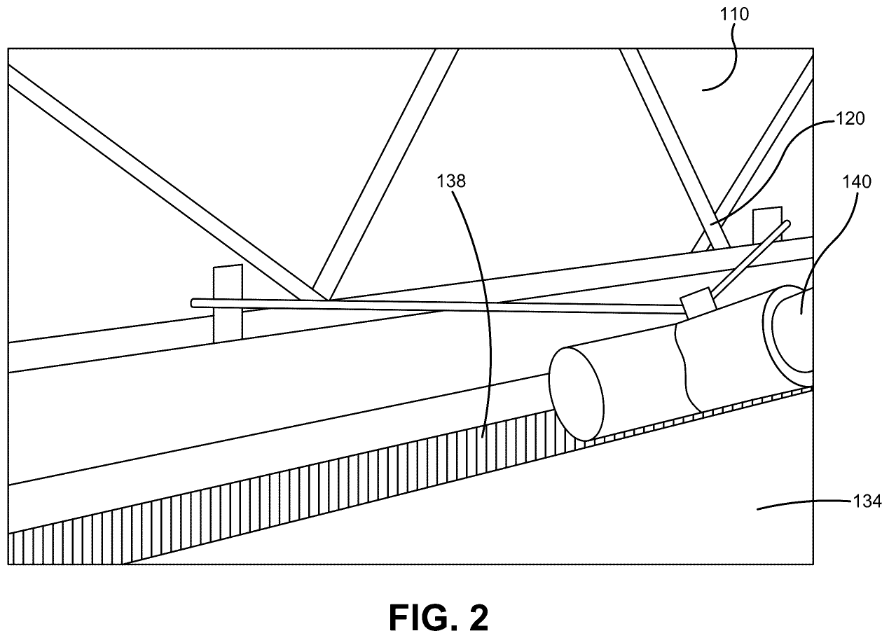

The device 100 is comprised of at least one roller assembly 130. The assembly 130 comprises at least one roller 134 that rotates around an axle 132 and is designed to facilitate movement across soft or uneven surfaces such as sand. To enhance traction, each roller 134 may include a tread pattern 136, allowing for smoother transport over rough terrain. The device 100 also incorporates at least one self-cleaning brush 138 positioned above each roller 134, as best seen in FIG. 2. As the roller rotates, the brush 138, made from bristles or flexible rubber, removes sand, dirt, and other particles, preventing buildup and maintaining the roller 134's functionality. This self-cleaning system reduces the need for manual cleaning, keeping the rollers 134 clear and allowing the device 100 to move smoothly over extended distances and challenging surfaces.

For added convenience, a powered version of the device 100 includes at least one electric motor 150 integrated with the roller assemblies 130. The motor 150 enables users to transport heavy loads with minimal physical effort, regardless of the weight or terrain difficulty. The motor 150 is powered by a rechargeable battery 154, which is continuously charged by at least one solar panel 152 mounted on the body 110. The solar panel 152 is strategically placed on an exterior surface of the body 110 to maximize sun exposure, ensuring consistent energy capture throughout the day. Composed of high-efficiency photovoltaic cells, the solar panel 152 converts sunlight into electrical energy, which is then stored in the battery 154.

The battery 154, specifically designed for outdoor use, is preferably a high-capacity lithium-ion or lithium-polymer battery, chosen for its energy density, long lifespan, and resistance to environmental factors. The battery 154 supplies power to the motor 150, enabling the roller assemblies 130 to move with minimal manual effort, particularly advantageous when navigating rough terrain with heavy loads.

In the motorized embodiment, a remote 160 enables users to control the motor 150 speed and roller assembly 130 direction wirelessly. This remote 160 features at least one button 162 that communicates with the motor 150 via a wireless signal, such as Bluetooth or RF. The remote control 160 allows for convenient operation, letting users adjust the device's 100 effortlessly even when pulling or pushing is impractical. This feature is especially useful for managing heavy loads over longer distances, as it reduces physical strain and enhances usability by allowing fine control of the device's 100 movement.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “roller wagon device” and “device” are interchangeable and refer to the roller wagon device 100 of the present invention.

Notwithstanding the forgoing, the roller wagon device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the roller wagon device 100 as shown in the FIGS. are for illustrative purposes only, and that many other sizes and shapes of the roller wagon device 100 are well within the scope of the present disclosure. Although the dimensions of the roller wagon device 100 are important design parameters for user convenience, the roller wagon device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A roller wagon device comprising:
a body;
a frame supporting the body;
a roller assembly attached to an axle, the roller assembly comprised of a roller;
a brush that contacts the roller; and
a handle coupled to the body.

2. The roller wagon device of claim 1, wherein the frame is comprised of a hinge.

3. The roller wagon device of claim 2, wherein the frame is comprised of a foldable frame.

4. The roller wagon device of claim 1 further comprised of a first fastener positioned on an interior of the body.

5. The roller wagon device of claim 1 further comprised of a second fastener positioned on an exterior of the body.

6. The roller wagon device of claim 2, wherein the body is comprised of an adjustable divider.

7. The roller wagon device of claim 1, wherein the handle is comprised of a grip area.

8. A roller wagon device comprising:
a body comprised of a fastener;
a handle;
a frame supporting the body, the frame comprised of a hinge; and
a roller assembly comprising a roller configured to rotate around an axle for facilitating movement across soft or uneven surfaces, the roller assembly comprising a brush positioned above the roller to remove debris from the roller during rotation.

9. The roller wagon device of claim 8, wherein the fastener is comprised of a clip.

10. The roller wagon device of claim 8, wherein the fastener is comprised of an adjustable strap.

11. The roller wagon device of claim 8, wherein the brush is comprised of a bristle.

12. The roller wagon device of claim 8, wherein the brush is comprised of a flexible rubber.

13. The roller wagon device of claim 8, wherein the roller is comprised of a tread pattern.

14. The roller wagon device of claim 8, wherein the handle is comprised of a telescopic handle.

15. The roller wagon device of claim 8, wherein the body is comprised of a fabric material.

16. A roller wagon device comprising:
a body;
a solar panel;
a frame supporting the body;
a roller assembly comprising a roller configured to rotate around an axle;
an electric motor operatively connected to the roller assembly to drive the roller;
a rechargeable battery configured to power the electric motor, the battery connected to the solar panel for recharging from a solar energy.

17. The roller wagon device of claim 16 further comprised of a remote control in wireless electrical communication with the electric motor.

18. The roller wagon device of claim 17, wherein the remote control is comprised of a button.

19. The roller wagon device of claim 18, wherein the button controls a speed of the electric motor.

20. The roller wagon device of claim 18, wherein the button controls a direction of the roller assembly.
